(19) United States
(12) Patent Application Publication
(10) Pub. No.: US 2026/0091470 A1
(43) Pub. Date: Apr. 2, 2026

(54) Driver Tool

(71) Applicant: Milwaukee Electric Tool Corporation, Brookfield, WI (US)

(72) Inventors: Lucas M. Schmidt, Eagle, WI (US); Marko Todorovic, Oak Creek, WI (US); Derek D. Rose, Menomonee Falls, WI (US); Cheng Zhang Li, Sussex, WI (US)

(21) Appl. No.: 19/306,262

(22) Filed: Aug. 21, 2025

Related U.S. Application Data
(60) Provisional application No. 63/702,257, filed on Oct. 2, 2024.
(60) Provisional application No. 63/735,501, filed on Dec. 18, 2024.
(60) Provisional application No. 63/752,032, filed on Jan. 31, 2025.

(51) Int. Cl. B25B 23/00; B25G 1/08

(52) U.S. Cl. CPC B25B 23/0007; B25G 1/085

(57) ABSTRACT

Various embodiments of a driver are provided. In various embodiments, the drivers described herein are configured to provide users the ability to select multiple different sized sockets to engage with fasteners and tool bits.

### CROSS-REFERENCE TO RELATED PATENT APPLICATIONS

The present application claims the benefit of and priority to U.S. Provisional Application No. 63/752,032 filed on Jan. 31, 2025, U.S. Provisional Application No. 63/735,501 filed on Dec. 18, 2024, and U.S. Provisional Application No. 63/702,257, filed on Oct. 2, 2024, each of which is incorporated herein by reference in its entirety.

### BACKGROUND OF THE INVENTION

The present disclosure is directed generally to the field of tools. The present disclosure relates specifically to a driver with multiple sockets and/or multiple bits.

### SUMMARY OF THE INVENTION

One embodiment of the invention relates to a driver including a handle and a first primary socket pipe. The handle includes a first socket end, an opposing second socket end, and a first channel extending through the handle between the first socket end and the second socket end. The first primary socket pipe includes a first end, an opposing third socket end, a first engagement portion between the first end and the third socket end, and a second channel extending through the first primary socket pipe from the first end to the third socket end. The first socket end is configured to receive and engage with the first engagement portion. The first socket end, the second socket end, and the third socket end are configured to engage with a different sized fastener from each other.

Another embodiment of the invention relates to a driver including a handle and a tool holder. The handle includes a first socket end, and an opposing first end, the first socket end defining a first diameter. The tool holder includes a second socket end, an opposing second end, and a shoulder extending radially away from the second end. The shoulder defines a second diameter larger than the first diameter. The first socket end is configured to receive and engage with the second end such that the shoulder interfaces against the first socket end to prevent further insertion of the tool holder into the first socket end. The first socket end and the second socket end are configured to engage with a different sized fastener from each other.

Another embodiment of the invention relates to a driver including a handle and a tool holder. The handle includes a first socket end defining a first diameter. The tool holder includes a second socket end, an opposing first end, a recess defined by the first end, and a projection component received in the recess and extending at least partially out of the recess. The projection component defines a second diameter larger than the first diameter. The first socket end is configured to receive and engage with the first end such that the projection component interfaces against the first socket end to prevent further insertion of the tool holder into the first socket end.

Various embodiments of the invention relate to a driver with a hollow core. In various embodiments, the driver includes driving components of various sizes such as different sized sockets for driving different sized nuts. In various embodiments, the handle includes a through bore and each of the driving components includes a through bore. In such embodiments, the driver allows for driving of different sized fasteners/nuts on an elongated threaded workpiece that extend through the hollow core of the driver during use.

In various embodiments, the driver includes a hollow handle that receives one or more socket component and/or one or more bit holders that removably support one or more screw driver bits.

One embodiment of the invention relates to a driver including a handle, a first primary socket pipe, and a second primary socket pipe. The handle includes a first socket end, an opposing second socket end, and a first channel extending through the handle between the first socket end and the second socket end. The first primary socket pipe includes a first end, an opposing third socket end, a first engagement portion between the first end and the third socket end, and a second channel extending through the first primary socket pipe from the first end to the third socket end. The first socket end is configured to receive and engage with the first engagement portion when first end is located within first socket end. The second primary socket pipe includes a second end, an opposing fourth socket end, a second engagement portion between the second end and the fourth socket end, and a third channel extending through the second primary socket pipe from the second end to the fourth socket end. The second socket end is configured to receive and engage with the second engagement portion when the second end is located within the second socket end. The first socket end, the second socket end, the third socket end, and the fourth socket end are configured to engage with different sized fasteners from each other.

In a specific embodiment, the fastener is selected from the group consisting of a bolt head and a nut.

Another embodiment of the invention relates to a driver including a handle and a primary socket. The handle includes a first socket end, an opposing second socket end, and a first channel extending through the handle between the first socket end and the second socket end. The primary socket includes a first end, an opposing third socket end, and a second channel extending through the primary socket between the first end and the third socket end. The first socket end is configured to receive and engage the first end. The first socket end, the second socket end, and the third socket end are configured to engage with different sized fasteners from each other.

Another embodiment of the invention relates to a driver including a handle and a first tool holder. The handle includes a first socket end and an opposing first end, the first socket end defining a first diameter. The first tool holder includes a second socket end, an opposing second end, and a shoulder extending radially away from the second end. The shoulder defines a second diameter larger than the first diameter. The first socket end is configured to receive and engage with the second end such that the shoulder interfaces against the first socket end to prevent further insertion of the first tool holder into the first socket end. The first socket end and the second socket end are configured to engage with a different sized fastener from each other.

In one embodiment, the shoulder is an integral projection integrally formed with a metal material of a body of the tool holder. In one embodiment, the integral projection is a collar extending completely around an outer surface of the body of the tool holder. In another embodiment, the shoulder is a ring coupled to an outer surface of a body of the tool holder.

Another embodiment of the invention relates to a driver including a handle and a first tool holder. The handle includes a first socket end and an opposing first end, the first socket end defining a first diameter. The first tool holder includes a second socket end, an opposing second end, a recess defined within the second end, and a ring located partially within the recess, the ring defining a second diameter larger than the first diameter. The first socket end is configured to receive and engage with the second end such that the ring interfaces against the first socket end to prevent further insertion of the first tool holder into the first socket end. The first socket end and the second socket end are configured to engage with a different sized fastener from each other.

Additional features and advantages will be set forth in the detailed description which follows, and, in part, will be readily apparent to those skilled in the art from the description or recognized by practicing the embodiments as described in the written description included, as well as the appended drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments. In addition, alternative exemplary embodiments relate to other features and combinations of features as may be generally recited in the claims.

### BRIEF DESCRIPTION OF THE DRAWINGS

This application will become more fully understood from the following detailed description, taken in conjunction with the accompanying figures, wherein like reference numerals refer to like elements in which:

FIG. 1 is an exploded side view of a driver, according to an exemplary embodiment.

FIG. 2 is a side view of a portion of the driver of FIG. 1, according to an exemplary embodiment.

FIG. 3 is a schematic cross-section view of the driver of FIG. 2, according to an exemplary embodiment.

FIG. 4 is an exploded side view of the driver of FIG. 1, according to an exemplary embodiment.

FIG. 5 is a schematic cross-section view of the driver of FIG. 1, according to an exemplary embodiment.

FIG. 6 is a side view of a driver, according to another exemplary embodiment.

FIG. 7 is a side view of the primary socket and secondary socket of FIG. 6, according to an exemplary embodiment.

FIG. 8 is an exploded side view of a portion of a driver, according to another exemplary embodiment.

FIG. 9 is a cross-section view of a portion of the driver of FIG. 8 and a tool holder, according to an exemplary embodiment.

FIG. 10 is a cross-section perspective view of a portion of the driver of FIG. 8 and the tool holder of FIG. 9, according to an exemplary embodiment.

FIG. 11 is a cross-section view of a portion of the driver of FIG. 8 and a tool holder, according to another exemplary embodiment.

### DETAILED DESCRIPTION

Referring generally to the figures, various embodiments of a driver are provided. In various embodiments, the driver has a hollow core (e.g., a central through bore that extends between opposing ends of the driver handle). The hollow core driver allows for driving of a fastener (e.g., a nut) along an elongate threaded workpiece or shaft that extends through the hollow core of the driver during use. In specific embodiments, the openings at either end of the handles include drive surfaces (e.g., hex drives) for driving a fastener. In various embodiments, the driver includes one or more socket pipes that are supported by the handle allowing the tool to be used to drive fasteners of additional different sizes.

As an example, the hollow core drivers described herein permit the driver to be slid around and along a large shaft, such as a threaded shaft extending several feet, until the driver engages with a fastener, such as a holt and/or a nut, even when the fastener is a larger distance (e.g., several inches or further) from the end of the shaft. In this way, the hollow core drivers permit users to use a hand-held driver to engage the fasteners rather than using other tools, such as pliers, to secure the fasteners on the shaft. As will be described, one or more of the hollow core drivers described herein include one or more socket pipes that can be coupled to an end of the handle and/or to other socket pipes to provide users a wide range of socket sizes that can be used with the hollow core drivers.

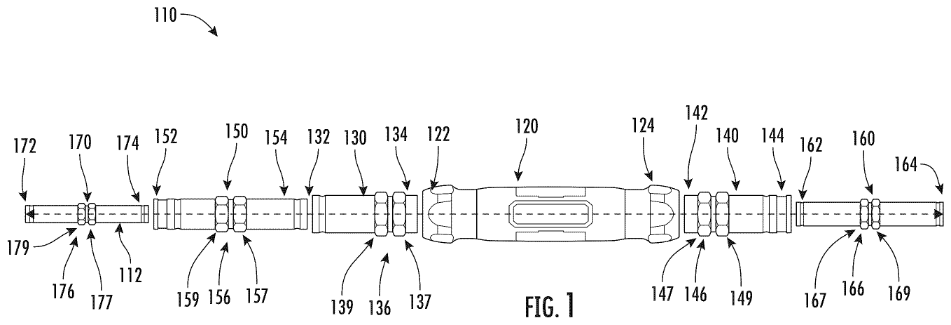

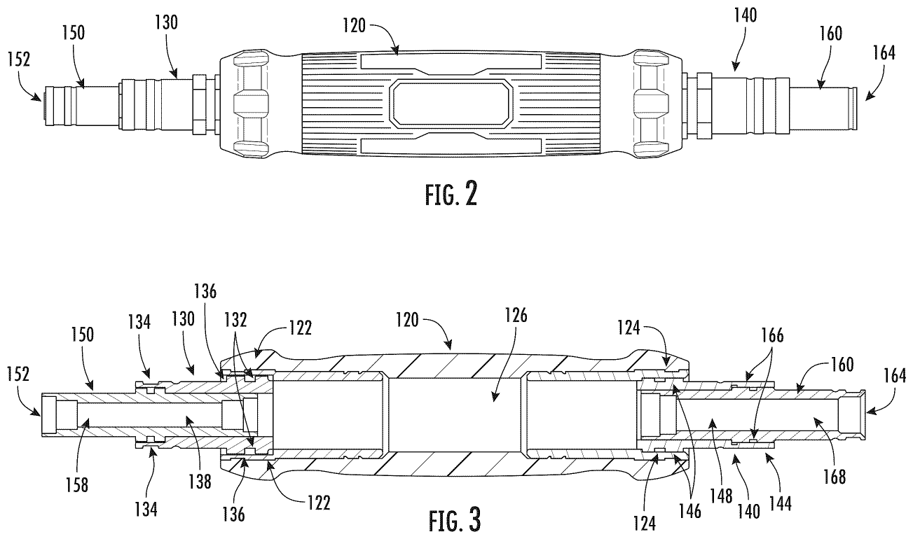

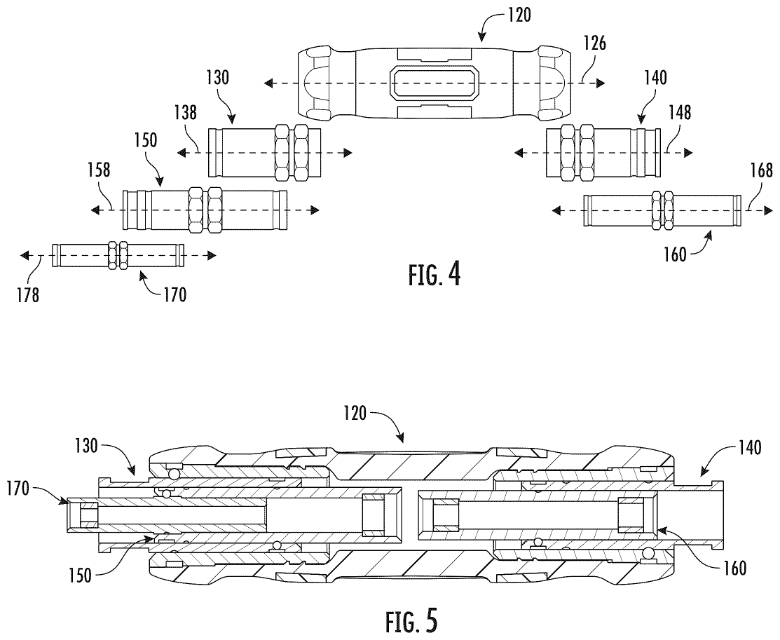

Referring to FIGS. 1-5, in one embodiment the driver includes a handle with a hollow core/central through bore and hollow core socket pipes extending from opposing ends of the handle. In one embodiment, the driver includes hollow core primary socket pipes that are not reversible. In another embodiment, the driver includes hollow core primary socket pipes that are reversible. Secondary reversible hollow core socket pipes are engageable with the primary socket pipes. These embodiments allow the user to select the desired sized socket to drive a nut of a particular size along the elongate workpiece. In a specific embodiment, the driver may also include a tertiary socket pipe that engages with the secondary socket pipes.

Referring to FIGS. 1-5, various aspects of a driving tool, such as driver 110, are shown. Driver 110 defines a channel 112 that extends through the driver 110. Channel 112 is collectively defined by the one or more components of driver 110 that are being used at a given time. When a fastener, such as a nut or a bolt head, is tightened on a relatively long shaft (e.g., several feet long), the user can customize the driver 110 to include a socket end that will engage the fastener, and then slide the driver 110 along the long shaft as the shaft extends through channel 112 until driver 110 engages with the fastener. In this way, users can use driver 110 to tighten and/or loosen fasteners that are located far away from an end of the respective shaft.

Driver 110 includes handle 120, first primary socket pipe 130, second primary socket pipe 140, first secondary socket pipe 150, second secondary socket pipe 160, and first tertiary socket pipe 170. The various socket pipes can be coupled to handle and/or each other to provide the user multiple different socket sizes (e.g., multiple hex shaped sockets) that engage with fasteners of multiple different sizes. In various embodiments, the fastener is selected from the group consisting of a bolt head and a nut.

As an example, in use a user first identifies the size of a fastener to be tightened or loosened. The user then identifies the socket end that would interface with the fastener, from the socket ends defined by handle 120, first primary socket pipe 130, second primary socket pipe 140, first secondary socket pipe 150, second secondary socket pipe 160, and first tertiary socket pipe 170. The user will optionally couple one of the primary socket pipes 130, 140 to handle 120, optionally also couple a secondary socket pipe 150, 160 to the primary socket pipe 130, 140, and optionally also couple first tertiary socket pipe 170 to the secondary socket pipe 150. The handle 120 and the selected socket pipes, if any, will collectively define channel 112 that extends through the entirety of driver 110. Finally, the user will slide handle 120 and the selected socket pipes, if any, along the shaft until the driver 110 engages with the fastener.

Handle 120 includes first socket end 122, opposing second socket end 124, and first channel 126 extending through handle 120 between the first socket end 122 and the second socket end 124. First channel 126 is configured to receive a shaft, such as a threaded shaft, that extends entirely through handle 120 past both first socket end 122 and second socket end 124.

First primary socket pipe 130 includes first end 134, an opposing third socket end 132, a first engagement portion 136 between the first end 134 and the third socket end 132, and a second channel 138 extending through the first primary socket pipe 130 from the first end 134 to the third socket end 132. In various embodiments, first channel 126 and second channel 138 extend collectively and continuously through the driver 110. The first socket end 122 is configured to receive and engage with the first engagement portion 136, thereby providing rotational engagement between handle 120 and first primary socket pipe 130. In various embodiments, the first socket end 122, the second socket end 124, and the third socket end 132 are configured to engage with a different sized fastener from each other. In various embodiments, the only end of first primary socket pipe 130 configured to be received by handle 120 is first end 134 being configured to be received by first socket end 122 of handle 120.

In various embodiments, the first primary socket pipe 130 is inserted into the handle 120 when the first socket end 122 is engaged with the first engagement portion 136. First engagement portion 136 includes first set of engagement surfaces 137 that circumferentially surrounds first primary socket pipe 130, the first set of engagement surfaces 137 engaging with the first socket end 122 when the first socket end 122 is engaged with the first engagement portion 136. First engagement portion 136 includes second set of engagement surfaces 139 that circumferentially surrounds first primary socket pipe 130 and that are distinct from first set of engagement surfaces 137. In various embodiments, first set of engagement surfaces 137 includes six surfaces symmetrically arranged around the first primary socket pipe 130.

Second primary socket pipe 140 includes a second end 142, an opposing fourth socket end 144, a second engagement portion 146 between the second end 142 and the fourth socket end 144, and a third channel 148 extending through the second primary socket pipe 140 from the second end 142 to the fourth socket end 144. Second socket end 124 is configured to receive and engage with the second engagement portion 146, thereby providing rotational engagement between handle 120 and second primary socket pipe 140. In various embodiments, the only end of second primary socket pipe 140 configured to be received by handle 120 is second end 142 being configured to be received by second socket end 124 of handle 120.

In various embodiments, the second primary socket pipe 140 is inserted into the handle 120 when the second socket end 124 is engaged with the second engagement portion 146. Second engagement portion 146 includes first set of engagement surfaces 147 that circumferentially surrounds second primary socket pipe 140, the first set of engagement surfaces 147 engaging with the second socket end 124 when the second socket end 124 is engaged with the second engagement portion 146. Second engagement portion 146 includes second set of engagement surfaces 149 that circumferentially surrounds second primary socket pipe 140 and that are distinct from first set of engagement surfaces 147. In various embodiments, first set of engagement surfaces 147 includes six surfaces symmetrically arranged around the second primary socket pipe 140.

First secondary socket pipe 150 includes fifth socket end 152, an opposing sixth socket end 154, a third engagement portion 156 between the fifth socket end 152 and the sixth socket end 154, and a fourth channel 158 extending through the first secondary socket pipe 150 from the fifth socket end 152 to the sixth socket end 154. The third socket end 132 (of first primary socket pipe 130) is configured to receive and engage with the third engagement portion 156, thereby providing rotational engagement between first primary socket pipe 130 and first secondary socket pipe 150. In various embodiments, both ends of first secondary socket pipe 150 are configured to be received by third socket end 132 (of first primary socket pipe 130), thereby providing the user flexibility regarding whether the fifth socket end 152 or the sixth socket end 154 will be furthest from the handle 120 and thus available to engage with a fastener.

In various embodiments, the first secondary socket pipe 150 is inserted into the first primary socket pipe 130 when the third socket end 132 is engaged with the third engagement portion 156. Third engagement portion 156 includes first set of engagement surfaces 157 that circumferentially surrounds first secondary socket pipe 150. Third engagement portion 156 includes second set of engagement surfaces 159 that circumferentially surrounds first secondary socket pipe 150 and that are distinct from first set of engagement surfaces 157. In various embodiments, first set of engagement surfaces 157 and/or second set of engagement surfaces 159 includes six surfaces symmetrically arranged around the first secondary socket pipe 150. In various embodiments, third socket end 132 is configured to receive and engage with first set of engagement surfaces 157 of the third engagement portion 156 in a first configuration in which the sixth socket end 154 is further than the fifth socket end 152 from the handle 120 and first primary socket pipe 130, and third socket end 132 is configured to receive and engage with second set of engagement surfaces 159 in a second configuration in which the fifth socket end 152 is further than the sixth socket end 154 from the handle 120 and first primary socket pipe 130.

Second secondary socket pipe 160 includes seventh socket end 162, an opposing eighth socket end 164, a fourth engagement portion 166 between the seventh socket end 162 and the eighth socket end 164, and a fifth channel 168 extending through the second secondary socket pipe 160 from the seventh socket end 162 to the eighth socket end 164. The fourth socket end 144 (of second primary socket pipe 140) is configured to receive and engage with the fourth engagement portion 166, thereby providing rotational engagement between second primary socket pipe 140 and second secondary socket pipe 160. In various embodiments, both ends of second secondary socket pipe 160 are configured to be received by fourth socket end 144 (of second primary socket pipe 140), thereby providing the user flexibility regarding whether the seventh socket end 162 or the eighth socket end 164 will be furthest from the handle 120 and thus available to engage with a fastener.

In various embodiments, the second secondary socket pipe 160 is inserted into the second primary socket pipe 140 when the fourth socket end 144 is engaged with the fourth engagement portion 166. Fourth engagement portion 166 includes first set of engagement surfaces 167 that circumferentially surrounds second secondary socket pipe 160. Fourth engagement portion 166 includes second set of engagement surfaces 169 that circumferentially surrounds second secondary socket pipe 160 and that are distinct from first set of engagement surfaces 167. In various embodiments, first set of engagement surfaces 167 and/or second set of engagement surfaces 169 includes six surfaces symmetrically arranged around the second secondary socket pipe 160. In various embodiments, fourth socket end 144 is configured to receive and engage with first set of engagement surfaces 167 of the fourth engagement portion 166 in a first configuration in which the eighth socket end 164 is further than seventh socket end 162 from the handle 120 and second primary socket pipe 140, and fourth socket end 144 is configured to receive and engage with second set of engagement surfaces 169 in a second configuration in which the seventh socket end 162 is further than the eighth socket end 164 from the handle 120 and second primary socket pipe 140.

First tertiary socket pipe 170 includes ninth socket end 172, an opposing tenth socket end 174, a fifth engagement portion 176 between the ninth socket end 172 and the tenth socket end 174, and a fifth channel 178 extending through the first tertiary socket pipe 170 from the ninth socket end 172 and the tenth socket end 174. The fifth socket end 152 (of first secondary socket pipe 150) is configured to receive and engage with the fifth engagement portion 176, thereby providing rotational engagement between first secondary socket pipe 150 and first tertiary socket pipe 170. In various embodiments, both ends of first tertiary socket pipe 170 are configured to be received by fifth socket end 152 (of first secondary socket pipe 150), thereby providing the user flexibility regarding whether the ninth socket end 172 or the tenth socket end 174 will be furthest from the handle 120 and thus available to engage with a fastener.

In various embodiments, the first tertiary socket pipe 170 is inserted into the first secondary socket pipe 150 when the fifth socket end 152 is engaged with the fifth engagement portion 176. Fifth engagement portion 176 includes first set of engagement surfaces 177 that circumferentially surrounds first tertiary socket pipe 170. Fifth engagement portion 176 includes second set of engagement surfaces 179 that circumferentially surrounds first tertiary socket pipe 170 and that are distinct from first set of engagement surfaces 177, the second set of engagement surfaces 179 engaging with the sixth socket end 154 when the sixth socket end 154 is engaged with the fifth engagement portion 176. In various embodiments, first set of engagement surfaces 177 and/or second set of engagement surfaces 179 includes six surfaces symmetrically arranged around the first tertiary socket pipe 170. In various embodiments, fifth socket end 152 is configured to receive and engage with first set of engagement surfaces 177 of the fifth engagement portion 176 in a first configuration in which the tenth socket end 174 is further than ninth socket end 172 from the handle 120 and first secondary socket pipe 150, and fifth socket end 152 is configured to receive and engage with second set of engagement surfaces 179 in a second configuration in which the ninth socket end 172 is further than the tenth socket end 174 from the handle 120 and first secondary socket pipe 150.

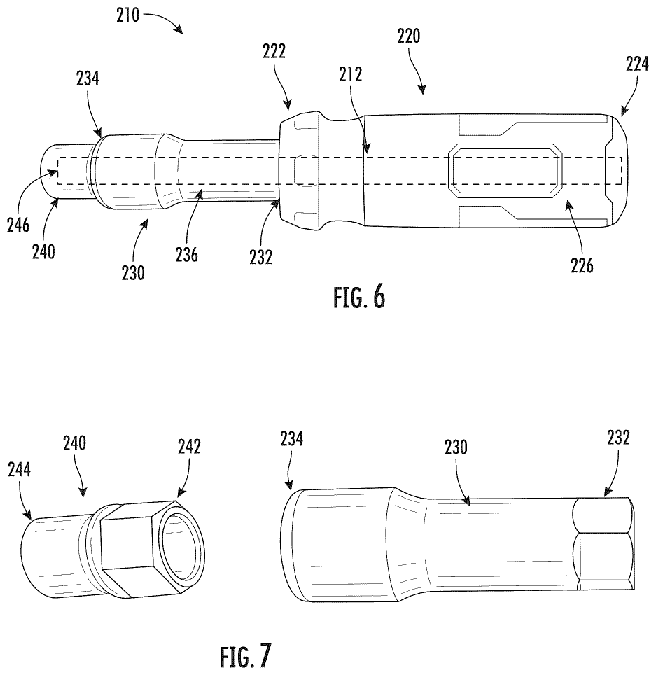

Referring to FIGS. 6-7, in one embodiment the driver includes a handle with a hollow core/central through bore and changeable sockets supported by the handle. In one embodiment, the driver includes a hollow core main socket pipe/adapter that engages the handle, and a changeable socket engages the main socket pipe/adapter. In some embodiments, the changeable socket may engage directly to socket openings in the handle without the use of the adapter. These embodiments allow the user to select the desired sized socket to drive a nut of a particular size along the elongate workpiece.

Referring to FIGS. 6-7, various aspects of a driving tool, such as driver 210, are shown. Driver 210, like driver 110, includes a channel that extends through the entirety of driver 210 and is configured to be adapted to drive multiple different sized bolt heads or nuts, and/or be coupled to different bits.

Driver 210 defines a channel 212 that extends through the driver 210. Channel 212 is collectively defined by the one or more components of driver 210 that are being used.

Driver 210 includes handle 220, primary socket 230, and secondary socket 240. Handle 220 includes first socket end 222, opposing second socket end 224, and first channel 226 extending through handle 220 between first socket end 222 and second socket end 224.

Primary socket 230 includes first end 232, opposing third socket end 234, and second channel 236 extending through primary socket 230 between first end 232 and third socket end 234. In various embodiments, the only end of primary socket 230 engageable with first socket end 222 of handle 220 is first end 232.

Secondary socket 240 includes second end 242, opposing third socket end 244, and third channel 246 extending through secondary socket 240 between second end 242 and third socket end 244. In various embodiments, second end 242 is engageable with third socket end 234 of primary socket 230.

Referring to FIGS. 8-11, in further embodiments a multi-bit, multi-nut driver is provided with a handle component that receives the multiple bit holders and/or socket drivers.

Referring to FIGS. 8-10, various aspects of a driving tool, such as driver 310, are shown. Driver 310 is configurable to couple to one or more extenders to increase the length between the socket end and the handle, and adjustable to drive multiple different sized bolt heads or nuts, and/or to be coupled to different bits.

Driver 310 includes handle 320, tool holder 330, first bit holder 340, shank 350, flip socket 360, second bit holder 370, and tool holder 380.

Handle 320 includes first socket end 322, and opposing first end 326. First socket end 322 defines a first diameter 324. Tool holder 330 includes second socket end 332, an opposing second end 334, and first engagement portion 336 between second socket end 332 and second end 334. First bit holder 340 includes third socket end 342, and opposing fourth socket end 344. Shank 350 includes third end 352, and opposing fourth end 354. Flip socket 360 includes fifth socket end 362, and opposing sixth socket end 364. Second bit holder 370 includes seventh socket end 372 and opposing eighth socket end 374.

In use, one or more of tool holder 330, first bit holder 340, shank 350, flip socket 360, and second bit holder 370 are configured to engage with handle 320 and/or each other. The various socket ends of handle 320, tool holder 330, first bit holder 340, shank 350, flip socket 360, and second bit holder 370 include different sized sockets from each other. Thus, driver 310 provides the ability to customize which size socket is being used to engage a fastener (e.g., a bolt head or a nut) and/or to engage with a tool bit, such as first bit 346, second bit 348, third bit 376, or fourth big 378.

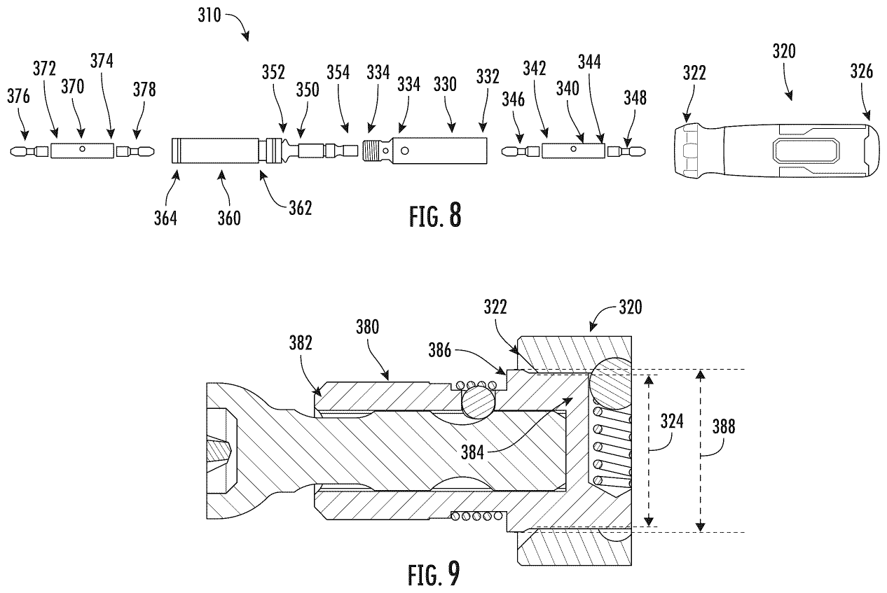

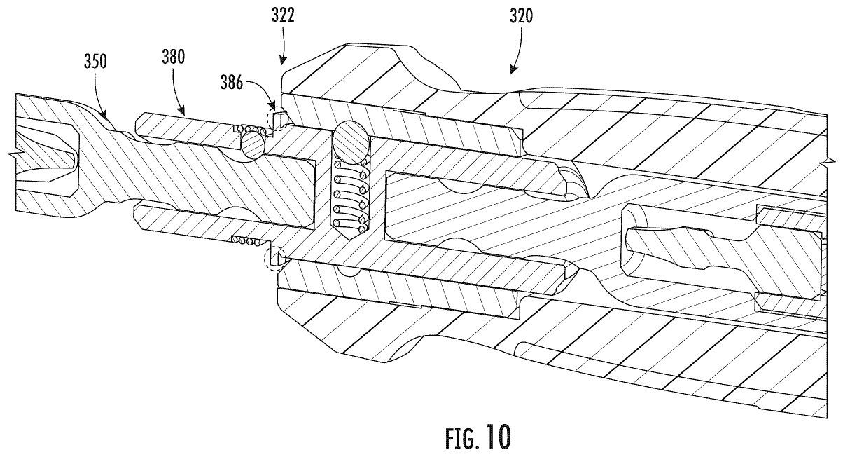

Referring to FIGS. 9-10, various aspects of tool holder 380 and handle 320 are shown. Tool holder 380 includes a second socket end 382, an opposing second end 384, and a shoulder 386 extending radially above second end 384. Shoulder 386 defines a diameter 388 that is greater than diameter 324 of first socket end 322 of handle 320. In use, first socket end 322 is configured to receive and engage with the second end 384 such that the shoulder 386 interfaces against the first socket end 322 to prevent further insertion of the tool holder 380 into the first socket end 322. In this way, shoulder 386 prevents tool holder 380 from engaging with first socket end 322 if second socket end 382 is inserted into first socket end 322 because shoulder 386 stops tool holder 380 from being inserted into first socket end 322 sufficiently far to engage with the interior surfaces of first socket end 322.

In various embodiments, driver 310 includes bit holder 340 configured to be received within the second socket end 382 of the tool holder 380, the bit holder 340 including a third socket end 342 and a fourth socket end 344. In various embodiments, one or more of the first socket end 322, the second socket end 332, the third socket end 342, and the fourth socket end 344 are configured to engage with a different sized fastener from each other. In various embodiments, shoulder 386 is integral with second end 384 of tool holder 380.

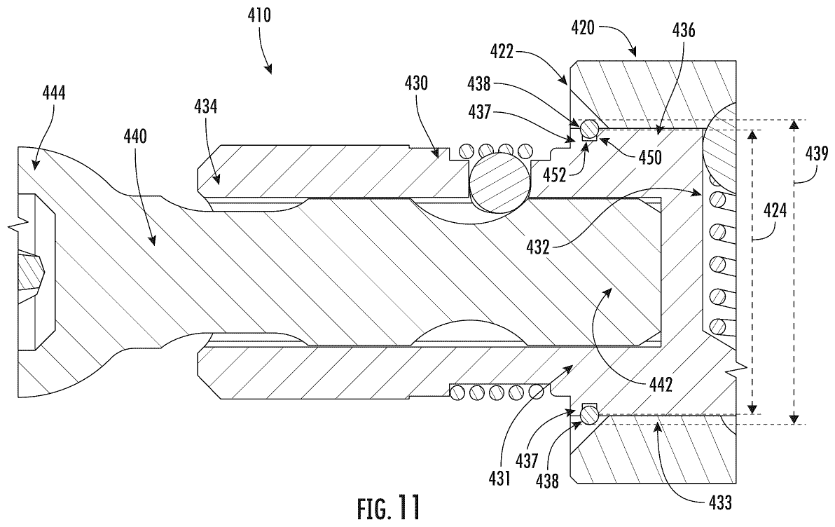

Referring to FIG. 11, various aspects of driver 410 are shown. Driver 410 is substantially the same as driver 310 except for the differences discussed herein. In particular, driver 410 is the same as driver 310 except for the differences described herein of including a recess 437 and projection component, shown as ring 438, rather than a shoulder 386.

Driver 410 includes handle 420, tool holder 430, and shank 440. Handle 420 includes first socket end 422, which defines diameter 424. Tool holder 430 includes first end 432, opposing second socket end 434, engagement portion 436 that engages with first socket end 422, recess 437 defined within first end 432, and ring 438, which is located at least partially within recess 437 and extends out of recess 437. In various embodiments, ring 438 is selected from the group consisting of a wire ring, such as a metal wire ring, and a c-clip. In various embodiments, recess 437 defines a ring that extends around first end 432. In various embodiments, recess 437 is formed by cutting into first end 432. Shank 440 includes second end 442 and opposing third socket end 444. Recess 437 defines an outer surface 450 of tool holder 430 and ring 438 defines an outer surface 452 that engages outer surface 450 defined by recess 437. In various embodiments, the first socket end 422 is configured to receive and engage with the first end 432 such that the projection component, shown as ring 438, interfaces against the first socket end 422 to prevent further insertion of the tool holder 430 into the first socket end 422.

Ring 438 defines diameter 439, which is larger than diameter 424. As a result, ring 438 prevents tool holder 430 from engaging with first socket end 422 if second socket end 434 is inserted into first socket end 422 because ring 438 stops tool holder 430 from being inserted into first socket end 422 sufficiently far to engage with the interior surfaces of first socket end 422.

In one embodiment, the ring 438 is a collar extending completely around an outer surface 433 of the body 431 of the tool holder 430. In another embodiment, the ring 438 is a ring coupled to an outer surface 433 of a body 431 of the tool holder 430. In various embodiments, ring 438 is a ring with an outer surface 452 that engages an outer surface 450 defined with the recess 437.

Additional details are shown and described in the accompanying figures.

It should be understood that the figures illustrate the exemplary embodiments in detail, and it should be understood that the present application is not limited to the details or methodology set forth in the description or illustrated in the figures. It should also be understood that the terminology is for description purposes only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one. As used herein, “rigidly coupled” refers to two components being coupled in a manner such that the components move together in a fixed positional relationship when acted upon by a force.

Various embodiments of the disclosure relate to any combination of any of the features, and any such combination of features may be claimed in this or future applications. Any of the features, elements or components of any of the exemplary embodiments discussed above may be utilized alone or in combination with any of the features, elements or components of any of the other embodiments discussed above.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A driver comprising:
a handle comprising a first socket end, an opposing second socket end, and a first channel extending through the handle between the first socket end and the second socket end; and
a first primary socket pipe comprising a first end, an opposing third socket end, a first engagement portion between the first end and the third socket end, and a second channel extending through the first primary socket pipe from the first end to the third socket end, wherein the first socket end is configured to receive and engage with the first engagement portion;
wherein the first socket end, the second socket end, and the third socket end are configured to engage with a different sized fastener from each other.

2. The driver of claim 1, wherein the first primary socket pipe is inserted into the handle when the first socket end is engaged with the first engagement portion, and the first channel and second channel extend collectively and continuously through the driver.

3. The driver of claim 1, the first engagement portion comprising a first set of engagement surfaces that circumferentially surround the first primary socket pipe, the first set of engagement surfaces engaging with the first socket end when the first socket end is engaged with the first engagement portion.

4. The driver of claim 3, wherein the first set of engagement surfaces comprise six surfaces symmetrically arranged around the first primary socket pipe.

5. The driver of claim 1, comprising a second primary socket pipe comprising a second end, an opposing fourth socket end, a second engagement portion between the second end and the fourth socket end, and a third channel extending through the first primary socket pipe from the first end to the third socket end, wherein the second socket end is configured to receive and engage with the second engagement portion.

6. The driver of claim 5, wherein the second primary socket pipe is inserted into the handle when the second socket end is engaged with the second engagement portion.

7. The driver of claim 5, comprising a first secondary socket pipe comprising a fifth socket end, an opposing sixth socket end, a third engagement portion between the fifth socket end and the sixth socket end, and a fourth channel extending through the first secondary socket pipe from the fifth socket end to the sixth socket end, wherein the third socket end is configured to receive and engage with the third engagement portion.

8. The driver of claim 7, wherein the third socket end is configured to receive and engage with the third engagement portion in a first configuration in which the sixth socket end is further from the handle than the fifth socket end, and a second configuration in which the fifth socket end is further from the handle than the sixth socket end.

9. The driver of claim 7, the third engagement portion comprising a first set of engagement surfaces that circumferentially surround the first secondary socket pipe and that engage with the second socket end when the third socket end is engaged with the third engagement portion.

10. The driver of claim 7, comprising a second secondary socket pipe comprising a seventh socket end, an opposing eighth socket end, a fourth engagement portion between the seventh socket end and the eighth socket end, and a fifth channel extending through the second secondary socket pipe from the seventh socket end to the eighth socket end, wherein the fourth socket end is configured to receive and engage with the fourth engagement portion.

11. The driver of claim 10, wherein the fourth socket end is configured to receive and engage with the fourth engagement portion in a first configuration in which the seventh socket end is further from the handle than the eighth socket end, and a second configuration in which the eighth socket end is further from the handle than the seventh socket end.

12. The driver of claim 10, wherein the first socket end, the second socket end, third socket end, the fourth socket end, fifth socket end, the sixth socket end, the seventh socket end, and the eighth socket end, are configured to engage with a different sized fastener from each other.

13. The driver of claim 10, comprising a first tertiary socket pipe comprising a ninth socket end, an opposing tenth socket end, a fifth engagement portion between the ninth socket end and the tenth socket end, and a sixth channel extending through the first tertiary socket pipe from the ninth socket end to the tenth socket end, wherein the fifth socket end is configured to receive and engage with the fifth engagement portion.

14. The driver of claim 13, wherein the first tertiary socket pipe is inserted into the first secondary socket pipe when the fifth socket end is engaged with the fifth engagement portion.

15. The driver of claim 13, the fifth engagement portion comprising a first set of engagement surfaces that circumferentially surround the first tertiary socket pipe and that engage with the fifth socket end when the fifth socket end is engaged with the fifth engagement portion.

16. A driver comprising:
a handle comprising a first socket end, and an opposing first end, the first socket end defining a first diameter; and
a tool holder comprising a second socket end, an opposing second end, and a shoulder extending radially away from the second end, the shoulder defining a second diameter larger than the first diameter, wherein the first socket end is configured to receive and engage with the second end such that the shoulder interfaces against the first socket end to prevent further insertion of the tool holder into the first socket end;
wherein the first socket end and the second socket end are configured to engage with a different sized fastener from each other.

17. The driver of claim 16, comprising a bit holder configured to be received within the second socket end of the tool holder, the bit holder comprising a third socket end and a fourth socket end, wherein the shoulder is integral with the second end of the tool holder.

18. The driver of claim 17, wherein the first socket end, the second socket end, the third socket end, and the fourth socket end are configured to engage with a different sized fastener from each other.

19. A driver comprising:
a handle comprising a first socket end defining a first diameter; and
a tool holder comprising a second socket end, an opposing first end, a recess defined by the first end, and a projection component received in the recess and extending at least partially out of the recess, the projection component defining a second diameter larger than the first diameter, wherein the first socket end is configured to receive and engage with the first end such that the projection component interfaces against the first socket end to prevent further insertion of the tool holder into the first socket end.

20. The driver of claim 19, wherein the first socket end and the second socket end are configured to engage with a different sized fastener from each other, wherein the projection component is a ring with an outer surface that engages an outer surface defined with the recess.
